(19) United States
(12) Patent Application Publication
(10) Pub. No.: US 2014/0259873 A1
(43) Pub. Date: Sep. 18, 2014

(54) Humane mousetrap with a novel entrance device

(71) Applicant: Shawn Zhu, Stormville, NY (US)

(72) Inventor: Shawn Zhu, Stormville, NY (US)

(21) Appl. No.: 13/830,704

(22) Filed: Mar. 14, 2013

(51) Int. Cl. A01M 23/08

(52) U.S. Cl. CPC A01M 23/08
USPC 43/61

(57) ABSTRACT

A two-piece, sanitary, safe and humane mousetrap comprising an entrance device and a container, wherein the entrance device comprises a tunnel, a one-way door, a mousetrap support piece, a fastening mechanism, and a door locking mechanism, is disclosed. Specifically, the mousetrap is formed by inserting the container to the entrance device from the back of the tunnel all the way to the one-way door. Preferably the one-way door comprises a pivotal wire door with a push-and-lock mechanism or comprises a gate with a touch-and-drop mechanism. The preferred entrance device is able to fit a common bottle. When the entrance device contains a flat rim fitted around the tunnel, the entrance device is capable of fitting containers of various sizes and shapes during repeated uses.

### BACKGROUND OF THE INVENTION

1. Field of the Invention

The present invention generally relates to a two-piece, sanitary, safe and humane mousetrap comprising an entrance device and a container, wherein the entrance device comprises a tunnel, a one-way door, a mousetrap support piece, a fastening mechanism, and a door locking mechanism.

The preferred entrance device is able to fit a common soft drink bottle and is able to fit containers of various sizes and shapes during repeated uses.

2. Description of the Prior Art

There has been a long history of using mousetraps. The designs of a mousetrap may be divided into two broad categories, one aiming at killing the mouse (such as a spring-loaded snap trap), and the other aiming at capturing the mouse alive within a closed container.

The most used mousetrap is a spring-loaded snap mousetrap. The spring-loaded snap mousetrap has achieved its popularity because of its low cost. But the spring-loaded snap mousetrap presents several serious disadvantages, including the possibility of injuring the users when setting the trap, household pets, and small children who may trigger the trap accidentally. Moreover, since the snapping force is usually very large, when a mouse is killed its blood is often spilled on the trap or even on the supporting surface. Disposing the trap with the dead mouse and cleaning the contaminated supporting surface are unsanitary and disgusting.

A live capture mousetrap, which doesn't kill the mouse after it is trapped, generally overcomes the disadvantages of a spring-loaded snap trap. Many types of live capture mousetraps have been disclosed, for examples, in the U.S. Pat. No. 1,138,132, U.S. Pat. No. 1,618,513, U.S. Pat. No. 3,177,608, U.S. Pat. No. 3,940,876, U.S. Pat. No. 4,550,523, U.S. Pat. No. 4,787,170, U.S. Pat. No. 5,564,221, U.S. Pat. No. 6,564,501, U.S. Pat. No. 7,458,182, and in a Chinese patent CN101878751A. The live capture mousetraps, for simplicity reasons, can be considered to comprise two sections: an entrance section with a door, which is capable of closing and locking itself after the mouse passes or after the mouse activates the door locking mechanism, and a baited container compartment section (or compartment which is connected to the entrance section) where the mouse remains after it is trapped. These live capture mousetrap designs can also be classified into two categories: a one-piece mousetrap where the entrance section with the door and the compartment are joined permanently in one piece as disclosed in U.S. Pat. No. 4,550,523, U.S. Pat. No. 4,787,170, U.S. Pat. No. 6,564,501, and U.S. Pat. No. 7,458,182, and a two-piece mousetrap where the entrance section with the door and the compartment (usually disposable) can be separated easily as disclosed in U.S. Pat. No. 1,618,513, U.S. Pat. No. 3,177,608, U.S. Pat. No. 3,940,876, U.S. Pat. No. 5,564,221, and Chinese patent CN101878751A.

The one-piece live capture mousetrap designs have a disadvantage compared to the two-piece live capture mousetrap designs. When a mouse is trapped, it tends to defecate abundantly inside the trap. If the mousetrap is one-piece, thorough cleaning of the interior compartment is difficult. As a result a user tends to throw the one-piece mousetrap away rather than reusing it. This makes it uneconomic and environmentally unfriendly.

The two-piece live capture mousetrap designs overcome the disadvantage of the one-piece live capture mousetrap designs because a two-piece live capture mousetrap permits the use of a readily available household container as the compartment (or enclosure), and the trapped mouse can be released in a humane way or disposed off together with the container. Examples are disclosed in U.S. Pat. No. 1,138,132, U.S. Pat. No. 1,618,513, U.S. Pat. No. 3,177,608, U.S. Pat. No. 3,940,876, U.S. Pat. No. 5,564,221, and Chinese patent CN101878751A.

The two-piece mousetraps designs of the prior arts, however, usually have four disadvantages: (1) the entrance devices can only fit a container with a specific mouth size; (2) the entrance devices don't allow the bypassing mouse to see the path to the bait; (3) the entrance devices may be contaminated by the waste of the trapped mouse; and (4) a trapped mouse can lift the door open and escape because there is no door locking mechanism in the design. The design in U.S. Pat. No. 1,138,132 employs a screen door and it has all four disadvantages. The design in U.S. Pat. No. 1,618,513 employs a spiky wire door and it has all four disadvantages. The design in U.S. Pat. No. 3,177,608 employs a pivotal door located outside of a tunnel. It only fits a plastic bag. A trapped mouse is likely to chew up the plastic bag and escape. In addition, it also has the disadvantages 2 and 3. The design in U.S. Pat. No. 3,940,876 employs a rectangular pivotal door without disclosing how the door works and it has all four disadvantages. The design in U.S. Pat. No. 5,564,221 employs a ball-sealing door and it has disadvantages 1, 2, and 3. The design in a Chinese patent CN101878751A employs a rectangular pivotal door and it has disadvantages 1, 2, and 3.

Making the entrance device needs to consume raw material such as plastic, metal, or wood. Even using recycled plastic requires extra energy to melt the plastic and to re-shape it into an entrance device. None of the prior arts mentions reuse of a cap from a common container to make the entrance device.

Therefore, there is a need for an improved mousetrap entrance device, which is low cost to use, which is reusable, which allows the bypassing mouse to see the passage to the baits in the compartment, which can prevent the trapped mouse from lifting the one-way door open from inside, and which does not allow the dirty feet of the trapped mouse to contaminate the inner walls of the entrance device. Preferably the entrance device allows the use of common soft drink bottles as the container. More preferably the entrance device allows the use of containers of various sizes and shapes during repeated use of the entrance device.

### SUMMARY OF THE INVENTION

A compartment, a bottle, or a container is an object that has only one opening and is large enough to house a mouse. The opening is called the mouth. Throughout the context of the present invention, compartment, container, and bottle may be used interchangeably. A tunnel always has an open front end as the entrance and an open back end as the exit (to the container), and a door is always a one-way door.

The mousetrap of the present invention comprises an entrance device and a container, wherein the entrance device comprises a tunnel, a one-way door, a mousetrap support piece, a fastening mechanism, and a door locking mechanism. Specifically, the mousetrap is formed by inserting the container from the back of the tunnel all the way to the one-way door. There are many types of one-way door that are suitable for the present invention. Preferably the one-way door comprises a pivotal wire door with a push-and-lock mechanism or comprises a gate with a touch-and-drop mechanism. More preferably the mousetrap support piece of the entrance device comprises a flat rim fitted around the tunnel so that the entrance device is capable of fitting containers of various sizes and shapes during repeated uses.

When the one-way door is a pivotal wire door, it hangs inside the tunnel and is capable of swinging inside the container mouth after the container has been fitted to the tunnel. The one-way pivotal wire door can adopt various shapes. One particular useful shape is a “U” shape with two door holes on top of each end. Another particular useful shape is a “U” shape with two door holes below the top of each end with a top crossbar connecting the two ends. The preferred door locking mechanism of this wire door comprises a push-and-lock mechanism, where the pushing action is carried out by the wire door and the locking action is carried out by a door locking piece. There are various configurations for the push-and-lock mechanism. That is, there are many methods to lock the wire door. For example, the pushing and locking action can occur either at the bottom of the wire door or on top of the wire door. That is, the wire door can be locked below or above its pivotal axis. The door locking piece can be a pivotal pin or a bendable locking strip with a hook. Generally the locking of the wire door results from the pushing of the door locking piece by the wire door, which is capable of swinging either due to gravity after the entering mouse passes the wire door or due to the pushing by a trapped mouse from inside.

When the one-way door is a gate, its movement is confined between a pair of vertical tracks. The preferred door locking mechanism of this gate comprises a touch-and-drop mechanism. In the initial set position of the mousetrap, the gate is resting on a pair of cliffs inside the two tracks at the tunnel entrance so as to leave an opening for a mouse to squeeze through. As the mouse enters the tunnel, the back of the mouse touches the bottom of the gate and forces the gate to move up and disengage from the cliffs. As the mouse passes the tunnel entrance, the gate drops down due to gravity and closes the entrance, trapping the mouse.

The two piece mousetrap constructed with the entrance device of the present invention permits a mouse to see the passage to the bait in the compartment, enter through the entrance opening of the entrance device when the entrance device is in initial set position, pass the one-way door, move towards the bait inside the compartment, and activate the door locking mechanism, resulting in locking the one-way door and trapping the mouse. In one embodiment the compartment is inserted in the tunnel all the way to the door so that the dirty feet of the trapped mouse are not able to contaminate the inner tunnel walls. Hence, the entrance device can be reused, if desired, without cleaning.

The shape of a tunnel can be rectangular or round.

When the tunnel is a round tunnel, it preferably has inner threads that can fit common soft drink bottles. More preferably, the round tunnel is constructed from a cap of a common soft drink bottle. When a bottle fits the entrance device to form a mousetrap, it inserts from the back of the tunnel all the way to the door. Thus when the mouse is trapped by the one-way door, the dirty feet of the mouse cannot contaminate the inner walls of the tunnel. A non-limiting example of a suitable cap is the cap of a soft drink bottle with an inner diameter of ˜2.8 cm and a height of ˜1.2 to ˜1.8 cm, such as a cap from a Coke® or Pepsi® bottle (20 Fl oz 591 ml). The entrance device of the present invention made from a Coke cap is naturally capable of mating a Coke bottle and a common water bottle in the United State. A preferred embodiment is an entrance device with a flat rim capable of fitting a container with a mouth bigger than the rear opening of the tunnel. When the entrance device comprises a round tunnel, the preferred containers suitable for the present invention are disposable soft drink plastic bottles with a mouth bigger than ˜1.5 cm in diameter. Useful common soft drink bottle includes, but not limited to, a plastic bottle of a Poland Spring® water bottle, a Deer Park® Natural Spring Water bottle, a Nirvana® water bottle, a Coke® bottle, a Pepsi® bottle, a 7-up® bottle, and a Skippy® peanut butter jar with a mouth opening of ˜6 cm.

When the tunnel is a rectangular tunnel, preferably the container is manufactured with a square mouth capable of inserting tightly from the back of the tunnel all the way to the door axis (when the door is a pivotal door) or to the door surface (when the door is a gate).

The material for constructing the components of the entrance device and compartment comprises metal, wood, bamboo, waxy cardboard or waxy paper, or a synthetic material such as plastic, or combination of them. Reuse of material to construct the parts of mousetrap is always desirable for environmental reasons. Like a round tunnel reusing a common bottle cap, a flat rim material may come from an old CD (or DVD) of ˜11.8 cm in diameter or its case.

When a mouse is trapped inside a common soft drink bottle, the bottle with trapped mouse inside can be capped conveniently with its own cap and disposed off without further emitting bad mouse odor from of the bottle. The entrance device can be reused to fit another bottle, if desirable, with a different mouth and/or compartment size, without cleaning.

Even though the word “mousetrap” is used throughout the context of the present invention, it should be noted that the invention can also be directed to rodent traps if the size of each component is made larger.

Other objects and advantages will become apparent to those skilled in the art from the following detailed description in conjunction with the appended claims and drawings attached hereto.

### BRIEF DESCRIPTION OF THE DRAWINGS

FIG. 1 is a prospective view of a round tunnel with inner threads and two symmetric door mounting holes.

FIG. 2 is a prospective view of a round tunnel with inner threads, two symmetric door mounting holes, two symmetric roof cutouts, one middle roof cutout, and a door restriction piece.

FIG. 3 is a prospective view of a wire door with two lower sidebars, a middle crossbar, one bottom crossbar, and two symmetric door holes on top of each lower sidebar.

FIG. 4 is a prospective view of a wire door with two symmetric door holes; two sidebars, each having an upper sidebar and a lower sidebar; a middle crossbar; one bottom crossbar; and one top crossbar.

FIG. 5 is a prospective view of a wire door similar to the wire door in FIG. 4 where the upper sidebar is bent at ˜90° angle.

FIG. 6 is a prospective view of a square tunnel with two symmetric door mounting holes and two symmetric roof cutouts; a bendable locking strip with a hook on the tunnel roof; and a pivotal door axis inserting into the two door mounting holes.

FIG. 7 is an assembly view, in prospective, of a mousetrap of the present invention showing that a square container with a square mouth is fitting the tunnel of FIG. 6 and that a pivotal wire door of FIG. 4 with a straight bottom crossbar has been mounted on the pivotal door axis of FIG. 6.

FIG. 8 is an assembly view, in prospective, of a flat rim with a round opening fitting the round tunnel of FIG. 1.

FIG. 9 is a prospective view of a round tunnel with a flat rim after the flat rim of FIG. 8 has been fitted to the exterior walls of the round tunnel of FIG. 8.

FIG. 10 is a prospective view of a mousetrap entrance device of the present invention showing a round tunnel similar to the tunnel in FIG. 1 with an additional bottom cutout fitted with a flat rim and a push-and-lock door locking mechanism comprising a wire door of FIG. 4 and a pivotal pin at the front floor of the round tunnel.

FIG. 11 is a prospective view of a pivotal pin in FIG. 10.

FIG. 12 is a prospective view of the round tunnel of FIG. 1 with a push-and-lock door locking mechanism comprising a wire door of FIG. 5 and a bendable locking strip with a hook on top of the roof of the round tunnel.

FIG. 13 is a prospective view of a round tunnel with a wire door where the round tunnel is the tunnel of FIG. 2 without the middle roof cutout, and where the door locking mechanism is a push-and-lock mechanism comprising a wire door of FIG. 4 and a bendable locking strip with a hook on top of the roof of the round tunnel.

FIG. 14 is a prospective view of a most preferred mousetrap of the present invention, in its initial set position, showing a round tunnel with a wire door of FIG. 13, a flat rim with an opening fitted to the rear exterior walls of the round tunnel, and a bottle inserted from the back of the round tunnel all the way to the pivotal door axis.

FIG. 15 is a prospective view of the mousetrap of FIG. 14, in its locked position, showing a trapped mouse inside the bottle.

FIG. 16 is a side sectional view of a mousetrap with an entrance device of FIG. 7 or FIG. 14, showing that a container with a mouth bigger than the exterior size of the tunnel has been fitted against the flat rim and fastened by a tying piece.

FIG. 17 is a prospective view of a mousetrap entrance device of the present invention showing a round tunnel of FIG. 2, a partial flat rim fitted at the bottom of the tunnel, and a push-and-lock door locking mechanism comprising a wire door of FIG. 4 and a pivotal pin close to the front roof of the round tunnel. The wire door with solid lines refers to an initial set position and the wire door with dotted lines refers to a locked position.

FIG. 18 is a prospective view of an entrance device of the present invention showing a rectangular tunnel with a pair of vertical tracks on the left and right entrance walls and a rectangular gate inserting to the tracks.

FIG. 19 is an assembly view, in prospective, of a mousetrap of the present invention, showing the entrance device of FIG. 18 fitting a rectangular container with a rectangular mouth.

FIG. 20 is a prospective view of a preferred mousetrap, in its initial set position, showing a round tunnel of FIG. 1 fitted inside the rectangular tunnel of FIG. 18, a flat rim fitted to the exterior of the tunnel, and a bottle inserted from the back of the round tunnel all the way to the gate.

### DETAILED DESCRIPTION OF THE INVENTION

In all figures, like numbers refer to similar parts. The drawings are not drawn in scale.

Referring to FIG. 1, there is an illustration of a round tunnel 1 with two symmetric door mounting holes 2 and inner threads 3 that can fit common bottles in a specific region. The two door mounting holes 2 are located close to the front entrance and below the tunnel ceiling in the upper the half of the tunnel. Tunnel front opening 4 and back opening 5 are also shown. In one embodiment the inner diameter of the front opening 4 is the same as the inner diameter of the mouth of the bottle. That is, the inner diameter of the front opening 4 may be slightly smaller than the inner diameter of the tunnel 1. In another word, the round tunnel has a “lip”.

Referring to FIG. 2, there is an illustration of a same round tunnel 1 as FIG. 1 except the round tunnel 1 in FIG. 2 has additional two symmetric roof cutouts 6, one middle roof cutout 7, and one door restriction piece 8 extending down from the tunnel ceiling to a location close to the line between the two door mounting holes 2. The depth (i.e., the backside) of the two roof cutouts 6 is near the vertical plane defined by the two door mounting holes 2. The two roof cutouts 6 are located by the door restriction 8.

Referring to FIG. 3, there is an illustration of a wire door with two lower sidebars 9, one bottom crossbar 10, a middle crossbar 11, and two symmetric door holes 12 on top of each lower sidebar 9. The two lower sidebars are connected by the bottom crossbar 10 at the bottom. The bottom crossbar 10 shown is a curved but in other cases the curvature preferably matches the curvature of the floor of a tunnel.

Referring to FIG. 4, there is an illustration of a wire door of FIG. 3 with two additional upper sidebars 13 above the two symmetric door holes 12 and a top crossbar 14 connecting the two upper sidebars on the top.

Referring to FIG. 5, there is an illustration of a wire door similar to the wire door in FIG. 4 where the upper sidebars are bent at ˜90° angle so that each upper sidebar has a vertical section 13 and a horizontal section 15.

Referring to FIG. 6, there is an illustration of a square tunnel 16 with two symmetric door mounting holes 2, two symmetric roof cutouts 6, a bendable locking strip 17 with a hook 18 on the tunnel roof, and a horizontal pivotal door axis 19 fixed at the two door mounting holes 2. The backside of the bendable locking strip 17 (the side without the hook 18) is anchored to the back roof of the tunnel 16. The front portion of the bendable locking strip 17 can move up when its hook 18 is pushed. The bendable locking strip 17 with a hook 18 serves as a locking piece in the push-and-lock door locking mechanism. The two symmetric door mounting holes 2 are located close to the front entrance and below the tunnel ceiling in the upper half of the tunnel 16. The depth (i.e., the backside) of the two roof cutouts 6 is near the vertical plane defined by the two door mounting holes 2.

Referring to FIG. 7, there is an illustration of a mousetrap of the present invention consisting of an entrance device to be fitted to a container. The entrance device consists of the piece of FIG. 6 and a wire door of FIG. 4 having a straight bottom crossbar where the wire door hangs on the pivotal door axis 19. The wire door is a square wire door and it consists of two lower sidebars 9, a bottom crossbar 10, a middle crossbar 11, two door holes 12, two upper sidebars 13, and one top crossbar 14. The top crossbar 14 is capable of reaching a height slightly above the front roof of the tunnel 16.

The container consists of a compartment 20, a square mouth 21 with opening 22. The exterior shape of the mouth 21 is similar to the interior shape of the tunnel 16 and the size of the mouth 21 is slightly smaller than the back opening 5 of the tunnel 16. To form a mousetrap, the container is inserted by turning from the back 5 of the tunnel 16 all the way to the pivotal door axis 19 so that the mouth opening 22 of the container touches the pivotal door axis 19.

The entrance device has a push-and-lock mechanism elucidated as follows. The pushing action is carried out by the top crossbar 14 of the wire door and the locking action is carried out by the bendable locking strip 17. The wire door is capable of swinging around the pivotal door axis 19 and inside the mouth 21 of the container, after the container mouth 21 has been fitted to the tunnel 16. However, the lower section of the wire door below the pivotal door axis 19 can't swing beyond the tunnel opening 4 of the rectangular tunnel 16 because as the wire door swings or as the wire door is pushed by a trapped mouse (not shown in the figure) outward, the two upper sidebars 13 move in opposite direction and hit the backsides of the two roof cutouts 6 and stop. The wire door can't be lifted open by the trapped mouse (not shown in the figure) from inside because of the hook 18 of the bendable locking strip 17. As the trapped mouse pushes the lower section of the wire door outward, the top crossbar 14 of the wire door swings in an opposite direction. As the top crossbar 14 swings it is able to push the hook 18 of the bendable locking strip 17 upward and is able to pass the tip of the hook 18. As soon as the top crossbar 14 of the wire door passes the hook 18, the bendable locking strip 17 returns to its initial position, locking the top crossbar 14 of the wire door between the hook 18 and the backsides of two cutouts 6.

Referring to FIG. 8, there is an illustration of a square flat rim 23 with a round opening 24 to be fitted to the round tunnel 1 of FIG. 1. The dimension of the round opening 24 is the same as the exterior dimension of the round tunnel 1.

Referring to FIG. 9, there is an illustration showing that the round tunnel 1 of FIG. 8 has been fitted to the flat rim 23 of FIG. 8. Two additional fastening holes 25 on the flat rim 23 are also shown.

Referring to FIG. 10, there is an illustration of a mousetrap entrance device of the present invention. The entrance device consists of a round tunnel 1 with a flat rim 23 similar to the one in FIG. 9, where the round tunnel 1 has an additional rectangular floor cutout 26, the pivotal door axis 19, a wire door of FIG. 3 hanging on the pivotal door axis 19, and a push-and-lock mechanism comprising a pivotal pin having a upper arm 27, a heavier lower arm 28, and a small pin hole 29 between the upper arm and the lower arm where the pivotal pin hangs on a pivotal pin axis 30 anchored on two pin mounting holes 31 on tunnel floor close to the entrance. The rectangular floor cutout has a front side 32. The vertical pole 33 is anchored on the floor of the tunnel entrance and it serves as a doorstop.

The lower arm 28 of the pivotal pin inserts through the cutout 26. The cutout 26 is capable of restricting rotational and horizontal movements of the pivotal pin. The push-and-lock principle of the push-and-lock mechanism of the door locking mechanism is elucidated as follows. The pushing action is carried out by the bottom crossbar 10 of the wire door and the locking action is carried out by the pivotal pin. The pivotal pin is the door locking piece in this example. After a mouse (not shown in the figure) is trapped and when it tries to escape, the mouse naturally pushes the wire door outward. The bottom crossbar 10 of the wire door in turn pushes down the upper arm 27 of the pivotal pin until it passes the tip of the upper arm 27 of the pivotal pin. As soon as the bottom crossbar 10 passes the tip of the upper arm 27, the pivotal pin swings back due to gravity due to the weight of the lower arm 28 of the pivotal pin. When the trapped mouse (not shown in the figure) is trying to push the wire door outward, the bottom crossbar 10 of the wire door is stopped by the vertical pole 33. When the trapped mouse (not shown in the figure) is trying to pull the wire door inward, the bottom crossbar 10 of the wire door is stopped by the upper arm 27 of the pivotal pin because the lower arm 28 of the pivotal pin is stopped by the front side 32 of the cutout 26. Hence the bottom crossbar 10 of the wire door is locked between the doorstop 33 and the upper arm 27 of the pivotal pin.

The round tunnel 1 with inner threads (threads not shown in FIG. 10 for clarity reasons) preferably is able to fit a common bottle so that the mouth of the common bottle touches the pivotal door axis 19 after the bottle has been fitted to the round tunnel 1.

A container fastening mechanism capable of fastening the container to the entrance device is also shown. The container fastening mechanism consists of two fastening holes 25 and a tying piece 34. This container fastening mechanism is necessary when the container has a mouth bigger than the exterior dimension of the tunnel. When the container is a common bottle, the fastening mechanism is not necessary because the round tunnel 1 with threads can fit the common bottle securely.

The flat rim 23 additionally functions as the mousetrap support.

The diameters of door holes 12 are slightly larger than the diameter of the pivotal door axis 19 so that the wire door is capable of freely swinging around the pivotal door axis 19. It should be noted that the wire door can be mounted, for example by welding, to the door axis 19 without the need of the two door holes 12. In this case, the door axis 19 can rotate freely inside the door mounting holes 2.

Referring to FIG. 11, there is an illustration of an example of the pivotal pin of FIG. 10.

Referring to FIG. 12, there is an illustration of a round tunnel of FIG. 1 with a push-and-lock door locking mechanism comprising a wire door of FIG. 5 and a bendable locking strip 17 with a hook 18 on top of the roof of the round tunnel. After a bottle and a flat rim have been fitted to this device, a mousetrap is formed and the mechanism of the mousetrap is similar to the mechanism described in FIG. 7.

Referring to FIG. 13, there is an illustration of a round tunnel of FIG. 2 without the middle roof cutout 7, a bendable strip 17 with a hook 18 anchored on the rear roof of the tunnel 1, and a wire door of FIG. 4 hanging on a pivotal door axis 19. The device has a push-and-lock door locking mechanism. The bottom of the door restriction piece 8 is slightly above the pivotal door axis 19 and the bottom width of the door restriction piece 8 is just slightly smaller than the distance between the two door holes 12. The door restriction piece 8 is capable of minimizing the horizontal movement of the wire door along the axis 19. However, it is not always necessary to have a door restriction piece 8 in the entrance device in this embodiment.

Referring to FIG. 14, there is an illustration of a most preferred mousetrap of the present invention. The mousetrap consists of the piece of FIG. 13, a flat rim 23 with a round opening fitted around the exterior back walls of the round tunnel 16, and a common bottle 20 fitted inside the round tunnel 1 with the bottle mouth 22 touching against the pivotal door axis 19. The mousetrap as shown is in its initial set position where the top crossbar 14 is in front of the hook 18 of the bendable locking strip 17. The trapping mechanism is described in next example.

Referring to FIG. 15, there is an illustration of the mousetrap of FIG. 14 in its locked position where the mouse 36 is trapped inside the bottle 20. The entrance device has the same push-and-lock mechanism as the one described in FIG. 7 and it is elucidate as follows. The wire door with a top crossbar 14 and two upper sidebars 13 is capable of swinging around the pivotal door axis 19 and inside the mouth of the container 20. However, the lower section of the wire door below the pivotal door axis 19 can't swing beyond the tunnel opening 4 because as the wire door swings or as the wire door is pushed by the trapped mouse 14 outward, the two upper sidebars 13 swing in opposite direction and are able to hit the backsides of the two roof cutouts 6 and stop. The wire door can't be lifted open by the trapped mouse 36 from inside because of the hook 18 of the bendable locking strip 17. As the trapped mouse 36 pushes the lower section of the wire door outward, the top crossbar 14 of the wire door swings in an opposite direction. As it swings, it is able to push the hook 18 of the bendable locking strip 17 upward and is able to pass the tip of the hook 18. As soon as the top crossbar 14 of the wire door passes the tip of the hook 18, the bendable locking strip 17 returns to its initial position, locking the top crossbar 14 of the wire door between the hook 18 and the backsides of two cutouts 6.

Referring to FIG. 16, there is an illustration of a sectional side view of a mousetrap consisting of an entrance device of FIG. 7 (or FIG. 14) and a container 20 with a bigger mouth than the exterior dimension of the tunnel 1 (or tunnel 16 in FIG. 14) where the container 20 is fitted against the flat rim 23 and tied securely by a tying piece 34.

Referring to FIG. 17, there is an illustration of a mousetrap entrance device consisting of a round tunnel 1 of FIG. 2, one partial flat rim 23 fitted at the bottom of the round tunnel 1, a pivotal door axis 19, a wire door of FIG. 4, and a push-and-lock mechanism with a pivotal pin. The pivotal pin is the same one used in FIG. 10 except that it is located above the pivotal door axis 19.

The pivotal pin mounting axis 30 is located across the front surface of the middle roof cutout 7 and is anchored on upper part of the door restriction piece 8. The shaded wire door in solid lines represents an initial set position where the top crossbar 14 of the wire door is in front of the upper arm 27 of the pivotal pin. The wire door in dotted lines represents a locked position where the top crossbar 14 of the wire door is behind the upper arm 27 of the pivotal pin. The principle of the push-and-lock mechanism is elucidated as follows. When the lower part of the wire door is pushed outward by a trapped mouse (not shown in the figure) from inside, the top crossbar 14 moves in opposite direct. The top crossbar 14 in turn pushes down the upper arm 27 of the pivotal pin into the middle roof cutout 7 and passes the tip of the upper arm 27. As soon as the top crossbar 14 passes the tip of the upper arm 27, the pivotal pin swings back to its original position due to gravity due to the weight of the lower arm 29 of the pivotal pin while the upper sidebars 13 of the wire door hit the backsides of the two roof cutouts 6 and stop. When the trapped mouse tries to pull or lift up the wire door inward, the wire door is not able to move because the top crossbar 14 of the wire door (dotted lines) is locked behind the upper arm 27 of the pivotal pin while the pin is not able to move downward and outward because the lower arm 29 of the pin is stopped by the door restriction piece 8. The door restriction piece 8 in this case serves as the doorstop. In addition, the door restriction piece 8 is able to restrict the horizontal movement of the wire door.

The use of a partial flat rim saves material. However, the entrance device with a partial flat rim doesn't allow the use of a container whose mouth size is bigger than the size of back opening of the tunnel anymore.

Referring to FIG. 18, there is an illustration of an entrance device of the present invention with a touch-and-drop door locking mechanism. The entrance device consists of a rectangular tunnel 16, a pair of vertical tracks on the left and right entrance walls of the tunnel, and a rectangular gate 37 as the one-way door capable of inserting to the tracks. Each track consists of a front vertical rail 38, a parallel rear vertical rail 39, and a bottom piece 40. There is also a cliff 41 on the back of the front vertical rail 38 where the cliff 41 is an extruding piece that can support the gate 37 before a mouse enters.

Referring to FIG. 19, there is an illustration of a mousetrap showing a container having a compartment 20 and a mouth 21 with an opening 22 to be fitted to the entrance device of FIG. 18 where the gate 37 has been inserted to the vertical tracks and supported by the cliffs 40. The size of the mouth 21 of the container is slightly smaller than the size of the tunnel 16 so that the mouth 21 can insert tightly into the tunnel 16 so as the mouth opening 22 touches against the rear vertical rails 39. The difference between the mousetrap of FIG. 19 and the mousetrap of FIG. 7 is in the door locking mechanism where in FIG. 19 the one-way door is a gate with a touch-and-drop mechanism and in FIG. 7 the one-way door is a wire door with a push-and-lock mechanism. The touch-and-dropping mechanism is described in next section.

Referring to FIG. 20, there is an illustration of a mousetrap, in its initial set position, with a touch-and-drop door locking mechanism comprising the device of FIG. 18. It shows that a round tunnel 1 with inner threads has been fitted inside the rectangular tunnel 16, that a common bottle 20 has been fitted to the round tunnel 1, and that a flat rim 23 has been fitted to the tunnel. The wall of front opening (or the mouth) of the round tunnel 1 joins the rear rails 39 of the two tracks and the left and right side walls of the round tunnel 1 joins the left and right side walls of the rectangular tunnel 16. The left and right side walls of the round tunnel 1 may be thicker than rest of the walls of the round tunnel 1. A container securing mechanism consisting of two holes 25 and a tying piece 34 is also shown. The mouth opening 22 of the common bottle 20 is capable of touching or almost touching the gate surface when the gate 37 is down. When the gate 37 is down, the bottom of the gate 37 is below the bottom of the round tunnel 1 and the gate 37 is capable of completely covering the round tunnel entrance. The flat rim 23 is preferably fitted around the rear exterior walls of the round tunnel 1. The entrance device of FIG. 20 not only is able to fit a common bottle but also a container with a mouth size bigger than the size of the round tunnel. Preferably the rectangular tunnel 16 with tracks, the flat rim 23 and the round tunnel 1 are one piece and can't be disassembled. In this case, the bottom wall of the rectangular tunnel is not necessary.

The mousetrap employs a touch-and-drop door locking mechanism. The touching action is carried out by an entering mouse 36 and the dropping action is carried out by the gate 37. The mousetrap as shown is in its initial set position, awaiting the mouse 36 to enter. The gate 37 is resting on the cliffs 41 so as to leave an opening for a mouse 36 to squeeze through. As the mouse 36 enters, the back of the entering mouse 36 is able to touch and push up the bottom of the gate 37, resulting in releasing the gate 37 from the cliffs 41. After the mouse 36 has reached the compartment 20, the gate 37 drops to the bottom pieces 40 of the tracks due to gravity, covering the bottle mouth 22 and blocking the exit to the mouse 36.

The mousetraps with a pivotal pin of FIG. 10 and FIG. 17 can be easily reset from a locked position to a set position by flipping the mousetrap ˜180°.

The middle crossbar 11 of a wire door serves as reinforcement to the wire door and as a roadblock to a trapped mouse. However, depending on the dimension of the tunnel entrance and the strength and size of the wire, the wire door may not need a middle crossbar. If the dimension of the entrance device is bigger, it may be necessary to have more than one middle crossbar to keep the mouse in.

The preferred material of the wire doors used in the entrance devices of the present invention is metal. The diameter of the wires preferably is between 0.5-2 mm, more preferably 0.8-1.2 mm, most preferably ˜1 mm.

It shall be understood that the mousetrap support pieces, the flat rim 23, if present, is on a support surface or ground (not shown in all figures) so that the mousetrap cannot roll over due to the movement of the mouse. The flat rim 23, in one embodiment, can move along the tunnel, in another embodiment, around the round tunnel. The opening 24 of the flat rim 23 doesn't have to be at the center of the flat rim 23. The flat rim 23 doesn't have to be rectangular shaped as long as it has a level bottom.

All of entrance devices with a flat rim can be reused to fit containers with various mouth sizes during repeated uses without cleaning. When the mouth of a container is bigger than the exterior dimension of the tunnel, the container is placed and fastened over the tunnel with the mouth of the container touching the flat rim.

What is claimed is:

1. A sanitary, safe, and humane mousetrap comprising
an entrance device and a detachable container with thin walls wherein the entrance device further comprises a tunnel, a one-way door, and a door locking mechanism, and wherein the container is inserted tightly inside the tunnel from the back all the way to the one-way door so that the mouth of the container almost touches the one-way door; and
wherein the mousetrap permits a mouse to
enter through the entrance opening of the entrance device when the entrance device is in initial set position,
pass the one-way door,
move towards the compartment with bait, and
activate the door locking mechanism,
resulting in locking the one-way door and trapping the mouse.

2. The mousetrap of claim 1
wherein the tunnel further comprises two symmetric door mounting holes adjacent the top of the tunnel and adjacent tunnel entrance;
wherein the one-way door is a pivotal door comprising a pivotal door axis wherein the pivotal door is capable of swinging around the pivotal door axis wherein the pivotal door axis passes through the two door mounting holes; and
Wherein the pivotal door is capable of blocking the tunnel entrance so as to trap the mouse once the mouse is inside the compartment.

3. The mousetrap of claim 2 wherein the pivotal door is a wire door comprising two lower sidebars below the pivotal door axis extending to a location close to the bottom of the mouth of the container, one bottom crossbar connecting the two lower sidebars at the bottom, and at least one middle crossbar across the two sidebars between the pivotal door axis and the bottom crossbar;
wherein the wire door is capable of swinging inside the container around the pivotal door axis;
wherein the door locking mechanism is a push-and-lock mechanism wherein the pushing action is carried out by the wire door and the locking action is carried out by a door locking piece; and
wherein the mousetrap
permits a mouse to enter through the entrance opening of the entrance device when the entrance device is in initial set position, pass the one-way door, move towards the compartment with bait,
permits the wire door to push the door locking piece when the wire door is pushed by the trapped mousse from inside and to pass the tip of the door locking piece,
permits the door locking piece to return to its original position after the wire door passes the tip of the door locking piece,
permits and the wire door to be stopped without moving beyond the entrance opening of the tunnel as soon as the wire door passes the tip of the door locking piece, and
permits the wire door to be stopped by the door locking piece when the wire door is pulled by the trapped mouse from inside.

4. The mousetrap of claim 3 wherein
the wire door additionally has two upper sidebars above the pivotal door axis extending from the two lower sidebars to a location slightly above the front roof of the tunnel wherein the two upper sidebars are connected by a top crossbar on top of the two upper sidebars,
the door locking mechanism is located above the pivotal door axis, and
the door locking piece
is a bendable locking strip with a hook wherein the end of the bendable locking strip without the hook is anchored on top of back roof of the tunnel or
is a pivotal pin comprising a upper arm, a heavier lower arm, and a small pin hole between the upper arm and the lower arm wherein the pivotal pin hangs on a pivotal pin axis.

5. The mousetrap of claim 1
wherein the one-way door comprises a rectangular gate capable of completely covering the container mouth, two vertical tracks on the left and right sides of the tunnel at the entrance of the tunnel wherein the bottoms of the two tracks are below the bottom of the container mouth, and two symmetrical cliffs on the front rails of the tracks;
wherein the movement of the gate is confined between the two vertical tracks,
wherein the gate, when the mousetrap is in its initial set position, is capable of resting on the cliffs so as to leave an opening for a mouse to squeeze through and
wherein the door locking mechanism is a touch-and-drop mechanism wherein the back of an entering mouse is able to touch the bottom of the gate, resulting in releasing the gate from the cliffs, dropping the gate due to gravity to the bottom of the tracks, covering the container mouth, and blocking the exit to the mouse.

6. The mousetrap of claim 4 wherein the container is a common soft drink bottle and the tunnel is a round tunnel with threads capable of fitting the common soft drink bottle.

7. The mousetrap of claim 5 wherein the container is a common soft drink bottle and the tunnel is a round tunnel with threads capable of fitting the common soft drink bottle.

8. A reusable, safe, and sanitary mousetrap entrance device comprising
the rectangular tunnel with vertical tracks with cliffs of claim 5;
the rectangular gate of claim 5;
a round tunnel with inner threads capable of fitting a common bottle wherein the round tunnel is fitted permanently inside the rectangular tunnel so that the mouth of the common bottle is capable of touching the gate surface when the gate is closed, wherein the opening wall of the round tunnel joins the rear rails of the tracks and the left and right side walls of the round tunnel joins the left and right side walls of the rectangular tunnel; and
a flat rim with an opening capable of fitting permanently either the exterior walls of the round tunnel or the exterior walls of the rectangular tunnel wherein the flat rim is capable of functioning as the mousetrap support piece and wherein the flat rim has a container securing means capable of fastening a container with a mouth bigger than the rear opening of the tunnel to the flat rim while the container covers the rear opening of the tunnel.

9. A mousetrap entrance device, capable of fitting a disposable container to form a humane live-capturing mousetrap, comprising
a one-way door,
a tunnel with a front and a rear opening, capable of supporting the one-way door and capable of connecting the opening of the entrance device to the mouth of the container, so as to form a secure passage between the entrance of the entrance device and the container compartment,
a mousetrap support piece comprising a flat rim having a level bottom,
a container fastening mechanism capable of fastening the container to the entrance device,
a door locking mechanism; and
wherein the mousetrap comprising the entrance device fitted to the container permits a mouse to enter through the entrance opening of the entrance device when the entrance device is in initial set position,
pass the one-way door,
move towards the container with bait, and
activate the door locking mechanism,
resulting in locking the one-way door and trapping the mouse.

10. The entrance device of claim 9 wherein the tunnel comprises two symmetric door mounting holes adjacent the top of the tunnel and adjacent tunnel entrance; wherein the one-way door comprises a pivotal door and a pivotal door axis wherein the pivotal door is capable of swinging inside the tunnel around the pivotal door axis wherein the pivotal door axis passes through the two door mounting holes; wherein the flat rim further comprises an opening of same shape and size as the exterior geometry of the tunnel wherein the flat rim is located in the back of the tunnel and the opening of the flat rim is fitted around the exterior walls of the tunnel.

11. The entrance device of claim 10
wherein the pivotal door comprises a wire door wherein the wire door further comprises two lower sidebars below the pivotal door axis extending to a location close to the bottom of the front opening of the tunnel, one bottom crossbar connecting the two lower sidebars at the bottom, and at least one middle crossbar across the two lower sidebars; and
wherein the door locking mechanism, located at a location adjacent the tunnel entrance either below or above the pivotal door axis, comprises a push-and-lock mechanism wherein the pushing action is carried out by the wire door and the locking action is carried out by a door locking piece capable of locking the wire door.

12. The entrance device of claim 11 wherein the wire door mounts to the pivotal door axis, wherein the wire door further comprises two upper sidebars above the pivotal door axis extending from the two lower sidebars to a location slightly above the front roof of the tunnel wherein the two upper sidebars are connected by a top crossbar on the top of the upper sidebars, and wherein the door locking piece comprises either a bendable locking strip with a hook or a pivotal pin.

13. The entrance device of claim 12
wherein the tunnel comprises a round tunnel with inner threads capable of mating a common bottle
wherein, after the bottle has been mated to the entrance device, the mouth of the bottle is capable of fitting against the pivotal door axis and wherein the lower portion of the wire door is capable of swinging inside the bottle,
wherein the door locking mechanism is located at the bottom of the tunnel,
wherein the pushing part of the push-and-lock mechanism is the bottom crossbar of the wire door, the door locking piece is a pivotal pin mounted to a pivotal pin axis anchored at two symmetric holes close to the floor of the tunnel entrance wherein the pivotal pin further comprises an upper arm, a heavier lower arm, and a small pin hole connecting the upper arm and the lower arm wherein the pivotal pin axis inserts through the small pin hole,
wherein the round tunnel further comprises a rectangular cutout on the floor of the round tunnel adjacent the entrance,
wherein the lower arm of the pivotal pin inserts through the rectangular cutout,
wherein the rectangular cutout is capable of limiting the horizontal movement of the pivotal pin along the pivotal pin axis and is capable of preventing the lower arm of the pivotal pin from moving outward, in turn preventing the upper arm of the pivotal pin from moving inward around the pivotal pin axis; and
wherein a mousetrap comprising the entrance device fitted to a container permits a mouse to see the passage to the bait,
permits the mouse to enter, when the mousetrap is in its initial set position wherein the bottom crossbar of the wire door is behind the upper arm of the pivotal pin when looking at the mousetrap facing the entrance, to the baited compartment,
permits the wire door to rotate,
permits the bottom bar of the wire door, when swinging outward or when pushed by the trapped mouse from inside, to hit and push down the upper arm of the pivotal pin,
permits the bottom crossbar of the wire door to pass the tip of the upper arm of the pivotal pin,
permits the upper arm of the pivotal pin to swing back due to gravity due to the weight of the lower arm of the pivotal pin, and
permits the wire door to be stopped without moving beyond the entrance opening of the tunnel as soon as the bottom crossbar of the wire door passes the tip of the upper arm of the pivotal pin when pushed by the trapped mouse or to be stopped by the pivotal pin when pulled by the trapped mouse.

14. The entrance device of claim 12
wherein the tunnel is a round tunnel with inner threads capable of mating a common bottle
wherein, after the bottle has been mated to the entrance device, the mouth of the bottle is capable of fitting against the pivotal door axis and the section of the wire door below the pivotal door axis is capable of swinging inside the bottle;
wherein the door locking mechanism is located above the pivotal door axis;
wherein the door locking piece of the door locking mechanism comprises a bendable locking strip with the end without the hook anchored on top of back roof the tunnel;
wherein the pushing action of the push-and-lock mechanism is carried out by the top crossbar of the wire door and the locking action is carried out by the bendable locking strip;
wherein the round tunnel further has two symmetric roof cutouts on top and at the edge of the front roof of the tunnel wherein the two roof cutouts are capable of accommodating snugly the two upper sidebars of the wire door when the wire door is pushed by a trapped mouse from inside; and
wherein a mousetrap comprising the entrance device fitted to a container permits a mouse to see the passage to the bait,
permits the mouse to enter, when the mousetrap is in its initial set position wherein the top crossbar of the wire door is in front of the hook of the bendable locking strip when looking at the mousetrap facing the entrance, to the baited compartment,
permits the wire door to rotate when pushed by the entering mouse,
permits the top crossbar of the wire door to push away the hook of the bendable locking strip and pass it when the wire door is pushed by the trapped mouse from inside,
permits the bendable locking strip to return to its initial position as soon as the top crossbar of the wire door passes the tip of the hook of the bendable locking strip,
permits the bendable locking strip to lock the top crossbar of the wire door, and
permits the wire door to be stopped by the ceiling of the tunnel without moving beyond the entrance opening of the tunnel as soon as the top crossbar of the wire door passes the tip of the hook of bendable locking strip when pushed by the trapped mouse from inside or to be stopped by the hook of the bendable locking strip when pulled by the trapped mouse from inside.

15. The entrance device of claim 12
wherein the tunnel is a round tunnel with inner threads capable of mating a common bottle
wherein, after the bottle has been mated to the entrance device, the mouth of the bottle is capable of fitting against the pivotal door axis and the section of the wire door below the pivotal door axis is capable of swinging inside the bottle,
wherein the round tunnel further comprises a door restriction piece extending down from the tunnel ceiling to a location close to the pivotal door axis, one middle roof cutout in the middle of the upper door restriction piece, and two symmetric roof cutouts by the sides of the door restriction piece on the top edge of the front roof of the tunnel wherein the two roof cutouts are capable of accommodating snugly the two upper sidebars of the wire door when the wire door is pushed by a trapped mouse from inside;
wherein the door locking mechanism is located above the pivotal door axis;
wherein the door locking piece comprises a pivotal pin wherein the pivotal pin hangs on a pivotal pin axis located across the front surface of middle roof cutout and is anchored on upper part of the door restriction piece, wherein the pivotal pin comprises a upper arm, a heavier lower arm, and a small pin hole between the upper arm and the lower arm;
wherein the pushing action of the push-and-lock mechanism is carried out by the top crossbar of the wire door and the locking action is carried out by the pivotal pin;
wherein a mousetrap comprising the entrance device fitted to a container permits a mouse to see the passage to the bait,
permits the mouse to enter, when the mousetrap is in its initial set position wherein the top crossbar of the wire door is in front of the upper arm of the pivotal pin of the door locking piece when looking at the mousetrap facing the entrance, to the baited compartment,
permits the wire door to rotate when pushed by the entering mouse,
permits the top crossbar of the wire door to push down the upper arm of the pivotal pin and pass it when the wire door is pushed by the trapped mouse from inside,
permits the pivotal pin to swing back to its initial position due to gravity as soon as the top crossbar of the wire door passes the tip of the upper arm of the pivotal pin,
permits the wire door to be stopped by the tunnel ceiling without moving beyond the entrance opening of the tunnel as soon as the top crossbar of the wire door passes the tip of the upper arm of the pivotal pin when pushed by the trapped mouse or to be stopped by the pivotal pin when pulled by the trapped mouse.

16. The entrance device of claim 14 wherein the round tunnel is constructed from a threaded cap of a soft drink bottle, wherein the threaded cap preferably is a cap of a 20 Fl oz (591 ml) Coke or Pepsi bottle with an inner diameter of ˜2.8 cm, an outer diameter of ˜3 cm, and a height of ˜1.2 cm.

17. The entrance device of claim 9 wherein the flat rim is capable of moving along the exterior walls of the tunnel.
